(19) United States
(12) Patent Application Publication
(10) Pub. No.: US 2019/0152397 A1
(43) Pub. Date: May 23, 2019

(54) Glare Reducing Mirror Assembly

(71) Applicants: Lori Edenfield, Opelika, AL (US); Deborah Clay, Opelika, AL (US)

(72) Inventors: Lori Edenfield, Opelika, AL (US); Deborah Clay, Opelika, AL (US)

(21) Appl. No.: 15/820,420

(22) Filed: Nov. 21, 2017

(51) Int. Cl. B60R 1/08; G02F 1/163; B60R 1/072; B60R 1/12

(52) U.S. Cl. CPC B60R 1/088; G02F 1/163; G02F 2201/58; B60R 1/1207; B60R 1/072

(57) ABSTRACT

A glare reducing mirror assembly for reducing glare for a driver of a vehicle includes a housing that is attached to an outside of a vehicle. A mirror is movably coupled to the housing to reflect light and the mirror is comprised of an electrochromic glass. A dimming unit is coupled to the housing to detect an intensity of light striking the mirror. The dimming unit is electrically coupled to the mirror and the dimming unit selectively adjusts an intensity of light being reflected by the mirror. In this way the dimming unit reduces glare for the driver.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to mirror devices and more particularly pertains to a new mirror device for reducing glare for a driver of a vehicle.

### BRIEF SUMMARY OF THE INVENTION

An embodiment of the disclosure meets the needs presented above by generally comprising a housing that is attached to an outside of a vehicle. A mirror is movably coupled to the housing to reflect light and the mirror is comprised of an electrochromic glass. A dimming unit is coupled to the housing to detect an intensity of light striking the mirror. The dimming unit is electrically coupled to the mirror and the dimming unit selectively adjusts an intensity of light being reflected by the mirror. In this way the dimming unit reduces glare for the driver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a glare reducing mirror assembly according to an embodiment of the disclosure.

FIG. 2 is a front view of an embodiment of the disclosure.

FIG. 3 is a front view of control of an embodiment of the disclosure.

FIG. 4 is a perspective in-use view of an embodiment of the disclosure.

FIG. 5 is a schematic view of an embodiment of the disclosure.

FIG. 6 is a perspective view of an alternative embodiment of the disclosure.

### DETAILED DESCRIPTION OF THE INVENTION

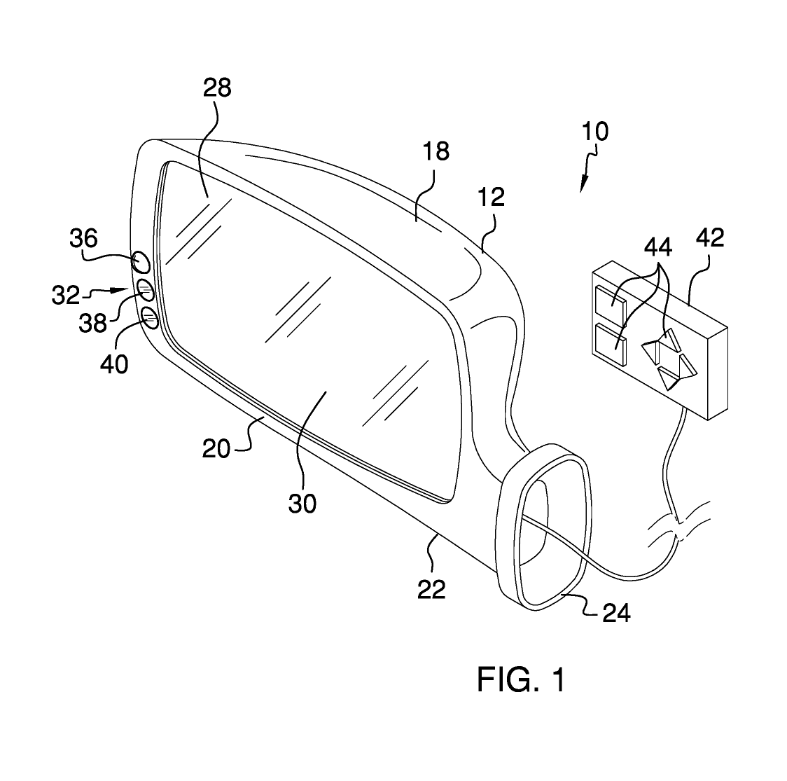

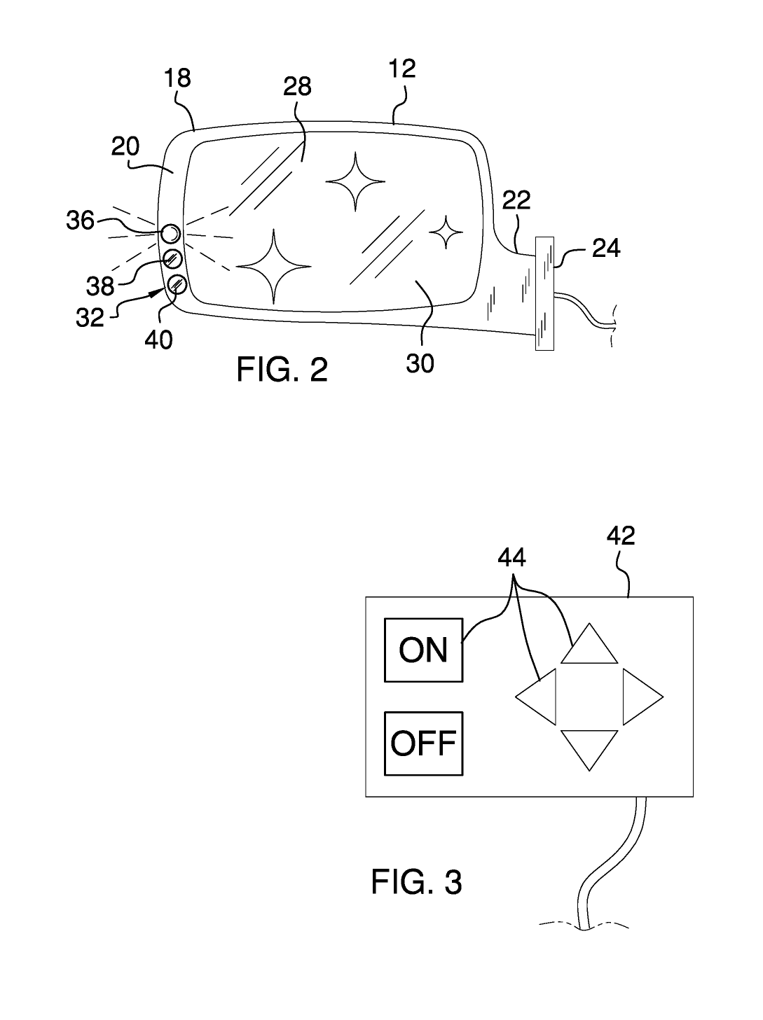

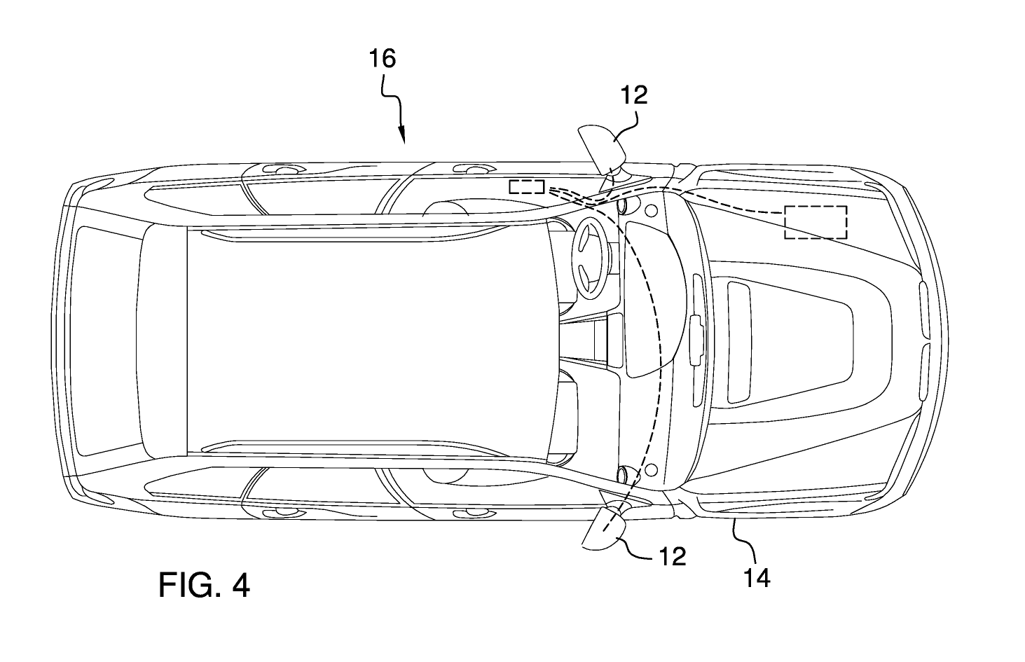

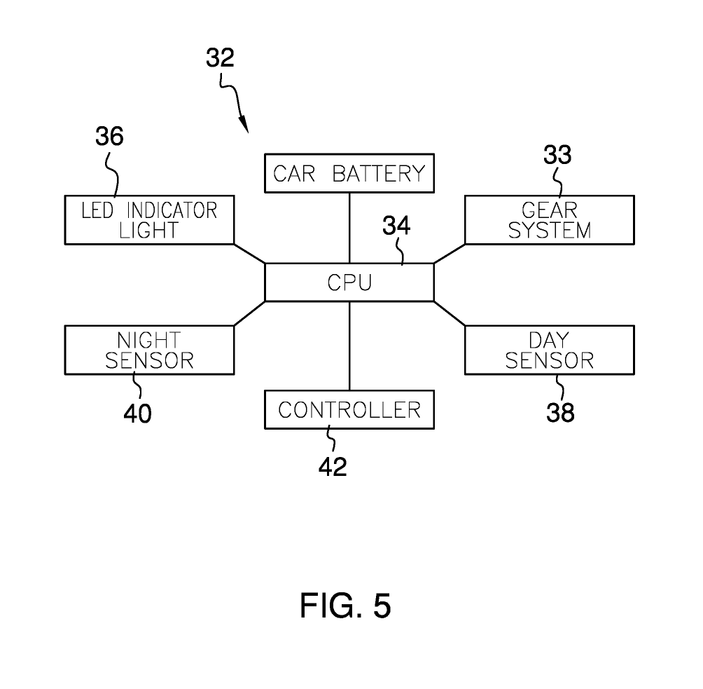

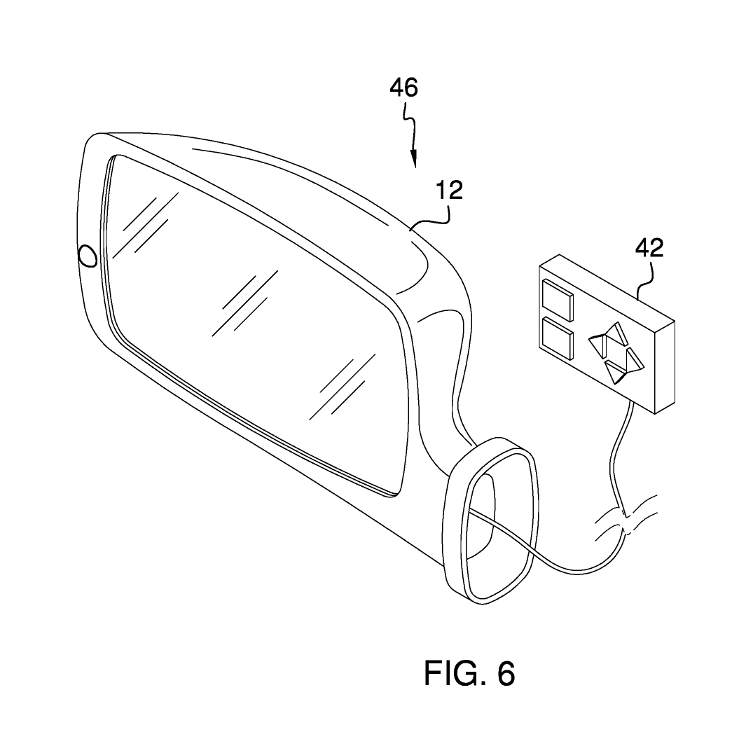

With reference now to the drawings, and in particular to FIGS. 1 through 6 thereof, a new mirror device embodying the principles and concepts of an embodiment of the disclosure and generally designated by the reference numeral 10 will be described.

As best illustrated in FIGS. 1 through 6, the glare reducing mirror assembly 10 generally comprises a housing 12 that may be attached to an outside 14 of a vehicle 16. The housing 12 has an outer wall 18 and the outer wall 18 has a perimeter edge 20. The outer wall 18 is concavely arcuate with respect to the perimeter edge 20 such that the housing 12 forms a dish. The housing 12 has a tubular portion 22 extending outwardly from the outer wall 18 and the tubular portion 22 has distal end 24 with respect to the outer wall 18. The distal end 24 is attached to the outside 14 of the vehicle 16 such that the housing 12 is spaced from the vehicle 16. Moreover, the perimeter edge 20 faces a rear side 26 of the vehicle 16 such that the housing 12 defines a side view mirror on the vehicle 16. The vehicle 16 may be a passenger vehicle for driving on a roadway or the like.

A mirror 28 is movably coupled to the housing 12 to reflect light. The mirror 28 is comprised of an electrochromic glass 30 such that the mirror's 28 reflective intensity can be adjusted. A dimming unit 32 is coupled to the housing 12 and the dimming unit 32 detects an intensity of light striking the mirror 28. The dimming unit 32 is electrically coupled to the mirror 28 and the dimming unit 32 selectively adjusts an intensity of light that is reflected by the mirror 28. In this way the dimming unit 32 reduces glare for the driver during night driving, driving when the sun is at a low angle and any other time when glare reduces the driver's ability to see. Additionally, a tilting unit 33 may be provided for adjusting an angle of the mirror with respect to the housing. The tilting unit 33 may be a power mirror adjustment of any conventional design.

The dimming unit 32 comprises a processor 34 that is positioned in the housing 12. The processor 34 is electrically coupled to an electrical system in the vehicle 16. The processor 34 selectively generates a dimming sequence and the processor 34 is electrically coupled to the mirror 28. The electrochromic glass 30 is actuated to reduce an amount of light that is reflected outwardly therefrom when the processor 34 generates the dimming sequence. In this way the mirror 28 reduces glare for a driver of the vehicle 16. The processor 34 may be an electronic processor 34 or the like and the dimming sequence may involve sequentially reducing the amount of light reflected between a minimum amount of light and a maximum amount of light.

A light emitter 36 is coupled to the housing 12 to emit light outwardly therefrom and the light emitter 36 is electrically coupled to the processor 34. The light emitter 36 is turned on when the processor 34 is turned on to notify the driver that the processor 34 is active. The light emitter 36 may be an LED or the like and the light emitter 36 may be positioned on the perimeter edge 20 of the housing 12 such that the light emitter 36 is visible to the driver.

A first light sensor 38 is coupled to the housing 12 to detect ambient light with respect to the housing 12. The first light sensor 38 is electrically coupled to the processor 34 and the first light sensor 38 may be an electronic light sensor of any conventional design. Additionally, the first light sensor 38 may be positioned on the housing 12 such that the first light sensor 38 faces a front side of the vehicle 16. A second light sensor 40 is coupled to the housing 12 to detect light that is directed toward the mirror 28 and the second light sensor 40 may be an electronic light sensor of any conventional design. The second light sensor 40 is electrically coupled to the processor 34. The processor 34 generates the dimming sequence when the second light sensor 40 detects an intensity of light that is greater than an intensity of light detected by the first light sensor 38. The second light sensor 40 may be positioned on the housing 12 to face the back side of the vehicle 16.

A control 42 is provided and the control 42 is electrically coupled to the processor 34 to control 42 operational parameters of the processor 34. The control 42 is positioned within the vehicle 16 to be accessible to the driver. The control 42 may include a housing and a conductor extending from the housing 12, through the distal end 24 of the tubular portion 22 of the housing 12 to the processor 34. The control 42 has a plurality of buttons 44 thereon and each of the buttons 44 controls operational parameters of the second light sensor 40 and the processor 34.

The plurality of buttons 44 may include an on/off button, a sensitivity increase button to increase the glare reduction and a sensitivity decrease button the decrease the glare reduction. The plurality of buttons 44 may additionally include a manual/auto button thereby facilitating the processor 34 to automatically adjust the intensity of light reflected by the mirror 28. The housing 12, mirror 28, dimming unit 32 and control 42 may be factory installed components of the vehicle 16. In an alternative embodiment 46 as shown in FIG. 6, each of the first light sensor 38 and the second light sensor 40 may be absent from the dimming unit 32 and the dimming unit 32 may be manually controlled with the control 42.

In use, the dimming unit 32 is selectively turned on during night time driving and when the sun is at a low angle. The processor 34 compares the intensity of ambient light sensed by the first light sensor 38 against the intensity of light sensed by the second light sensor 40. The processor 34 generates the dimming sequence then the second light sensor 40 senses an intensity of light that exceeds an intensity of ambient light sensed by the first light sensor 38. In this way the dimming unit 32 reduces glare from the side view mirror 28 of the vehicle 16 thereby enhancing visibility for the driver.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A glare reducing mirror assembly being configured to selectively adjust and intensity of light reflected from said assembly, said assembly comprising:
a housing being configured to be attached to an outside of a vehicle;
a mirror being movably coupled to said housing wherein said mirror is configured to reflect light, said mirror being comprised of an electrochromic glass; and
a dimming unit being coupled to said housing wherein said dimming unit is configured to detect an intensity of light striking said mirror, said dimming unit being electrically coupled to said mirror such that said dimming unit selectively adjusts an intensity of light being reflected by said mirror wherein said dimming unit is configured to reduce glare for the driver.

2. The assembly according to claim 1, further comprising said housing has an outer wall, said outer wall having a perimeter edge, said outer wall being concavely arcuate with respect to said perimeter edge such that said housing forms a dish, said housing having a tubular portion extending outwardly from said outer wall, said tubular portion having distal end with respect to said outer wall wherein said distal end is configured to be attached to the outside of the vehicle such that said housing is spaced from the vehicle having said perimeter edge facing a rear side of the vehicle.

3. The assembly according to claim 2, wherein said dimming unit comprises a processor being positioned in said housing, said processor being configured to be electrically coupled to an electrical system in the vehicle, said processor selectively generating a dimming sequence, said processor being electrically coupled to said mirror.

4. The assembly according to claim 3, wherein said electrochromic glass is actuated to reduce an amount of light being reflected outwardly therefrom when said processor generates said dimming sequence wherein said mirror is configured to reduce glare for a driver of the vehicle.

5. The assembly according to claim 3, further comprising a light emitter being coupled to said housing wherein said light emitter is configured to emit light outwardly therefrom, said light emitter being electrically coupled to said processor, said light emitter being turned on when said processor is turned on wherein said light emitter is configured to notify the driver that said processor is active.

6. The assembly according to claim 3, further comprising a first light sensor being coupled to said housing wherein said first light sensor is configured to detect ambient light with respect to said housing, said first light sensor being electrically coupled to said processor.

7. The assembly according to claim 6, further comprising a second light sensor being coupled to said housing wherein said second light sensor is configured to detect light being directed toward said mirror, said second light sensor being electrically coupled to said processor, said processor generating said dimming sequence when said second light sensor detects an intensity of light that is greater than an intensity of light detected by said first light sensor.

8. The assembly according to claim 7, further comprising a control being electrically coupled to said processor wherein said control is configured to be manipulated, said control being positioned within the vehicle wherein said control is configured to be accessible to the driver, said control having a plurality of buttons thereon wherein each of said buttons is configured to be selectively manipulated, each of said buttons controlling operational parameters of said second light sensor and said processor.

9. A glare reducing mirror assembly being configured to selectively adjust and intensity of light reflected from said assembly, said assembly comprising:
a housing being configured to be attached to an outside of a vehicle, said housing having an outer wall, said outer wall having a perimeter edge, said outer wall being concavely arcuate with respect to said perimeter edge such that said housing forms a dish, said housing having a tubular portion extending outwardly from said outer wall, said tubular portion having distal end with respect to said outer wall wherein said distal end is configured to be attached to the outside of the vehicle such that said housing is spaced from the vehicle having said perimeter edge facing a rear side of the vehicle;
a mirror being movably coupled to said housing wherein said mirror is configured to reflect light, said mirror being comprised of an electrochromic glass;
a dimming unit being coupled to said housing wherein said dimming unit is configured to detect an intensity of light striking said mirror, said dimming unit being electrically coupled to said mirror such that said dimming unit selectively adjusts an intensity of light being reflected by said mirror wherein said dimming unit is configured to reduce glare for the driver, said dimming unit comprising:
a processor being positioned in said housing, said processor being configured to be electrically coupled to an electrical system in the vehicle, said processor selectively generating a dimming sequence, said processor being electrically coupled to said mirror, said electrochromic glass being actuated to reduce an amount of light being reflected outwardly therefrom when said processor generates said dimming sequence wherein said mirror is configured to reduce glare for a driver of the vehicle;
a light emitter being coupled to said housing wherein said light emitter is configured to emit light outwardly therefrom, said light emitter being electrically coupled to said processor, said light emitter being turned on when said processor is turned on wherein said light emitter is configured to notify the driver that said processor is active;
a first light sensor being coupled to said housing wherein said first light sensor is configured to detect ambient light with respect to said housing, said first light sensor being electrically coupled to said processor;
a second light sensor being coupled to said housing wherein said second light sensor is configured to detect light being directed toward said mirror, said second light sensor being electrically coupled to said processor, said processor generating said dimming sequence wherein said second light sensor detects an intensity of light that is greater than an intensity of light detected by said first light sensor; and
a control being electrically coupled to said processor wherein said control is configured to be manipulated, said control being positioned within the vehicle wherein said control is configured to be accessible to the driver, said control having a plurality of buttons thereon wherein each of said buttons is configured to be selectively manipulated, each of said buttons controlling operational parameters of said second light sensor and said processor.
